(19) United States
(12) Patent Application Publication
(10) Pub. No.: US 2025/0260775 A1
(43) Pub. Date: Aug. 14, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: YUKI ISHIDA, Kanagawa (JP); HIROYASU KUNIEDA, Kanagawa (JP); AKITOSHI YAMADA, Kanagawa (JP); YOICHI KASHIBUCHI, Kanagawa (JP)

(21) Appl. No.: 19/052,045

(22) Filed: Feb. 12, 2025

(30) Foreign Application Priority Data
Feb. 13, 2024 (JP) 2024-019860

(51) Int. Cl. H04N 1/32; H04N 1/00

(52) U.S. Cl. CPC H04N 1/32149; H04N 1/32352; H04N 1/00856; H04N 2201/3233

(57) ABSTRACT

An image processing apparatus that embeds a pattern including a specific frequency characteristic in print data to add additional information to the print data, the image processing apparatus includes a print data obtaining unit configured to obtain data to be printed on a print medium, and a multiplexing unit configured to perform multiplexing processing on the additional information to be embedded in the print data, wherein the additional information to be subjected to the multiplexing processing by the multiplexing unit is formed of a first shape and a second shape within a region on the print medium, and wherein the first shape is created based on the additional information, the second shape contacts with the first shape, and a part of the first shape is larger than another part of the first shape.

### BACKGROUND

### Field of the Disclosure

The present disclosure relates to information multiplexing processing on an original.

### Description of the Related Art

In recent years, a technique for utilizing and storing an electronic document as an original document instead of using a paper document has been implemented. As a result, an electronic document is sometimes considered as an original document and paper on which the electronic document is printed is considered as a copy of the original document.

Under such circumstances, a method for embedding additional information about the authenticity in a printed document for the purpose of authenticity verification of texts printed on the paper is used. In printing on paper, a document is generated using various printing methods, such as an electrophotographic method and an inkjet method. Japanese Patent Application Laid-Open No. 2021-97270 discusses a technique for embedding inconspicuous information in a print product. Japanese Patent Application Laid-Open No. 2021-97270 also discusses a technique for embedding information in a region with a plurality of frequencies, which allows restoration of data to be performed appropriately even using imaging devices with different resolution performances.

However, in the above-described conventional technique, the additional information is extracted from a copy when a print product in which the additional information has been embedded is copied by a copying machine.

### SUMMARY

According to embodiments of the present disclosure, an image processing apparatus that embeds a pattern including a specific frequency characteristic in print data to add additional information to the print data, the image processing apparatus includes a print data obtaining unit configured to obtain data to be printed on a print medium, and a multiplexing unit configured to perform multiplexing processing on the additional information to be embedded in the print data, wherein the additional information to be subjected to the multiplexing processing by the multiplexing unit is formed of a first shape and a second shape within a region on the print medium, and wherein the first shape is created based on the additional information, the second shape contacts with the first shape, and a part of the first shape is larger than another part of the first shape.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of a printing system.

FIG. 2A is a flowchart illustrating authentic document identification (ID) information embedding processing, and FIG. 2B is a flowchart illustrating extraction processing.

FIG. 3 is a diagram illustrating an example of document data.

FIGS. 4A to 4C are diagrams each illustrating a mask for creating an image change.

FIGS. 5A to 5C are diagrams each visually illustrating a pattern.

FIGS. 6A to 6C are diagrams each illustrating a mask for creating an image change.

FIGS. 7A to 7C are diagrams each visually illustrating a pattern.

FIG. 8 is a diagram illustrating a user interface (UI) for document authenticity printing and copy prevention processing.

FIG. 9 is a flowchart illustrating multiplexing encoding processing.

FIGS. 10A to 10C are diagrams each illustrating a modified example of a mask that is for the copy prevention processing to create an image change in embedding authentic document ID information.

FIGS. 11A to 11C are diagrams each illustrating a pattern using a modified example of the mask that is for the copy prevention processing in embedding authentic document ID information.

FIGS. 12A to 12C are diagrams each illustrating another modified example of a mask that is for the copy prevention processing to create an image change in embedding authentic document ID information.

FIGS. 13A to 13C are diagrams each illustrating a pattern using still another modified example of the mask that is for the copy prevention processing in embedding authentic document ID information.

FIGS. 14A and 14B are diagrams each illustrating a mask that is for creating an image change in an image portion in embedding authentic document ID information.

FIGS. 15A and 15B are diagrams each illustrating a pattern that is generated in the image portion in embedding authentic document ID information.

FIG. 16 is a diagram illustrating a region on which document ID information is superimposed.

FIG. 17A is a schematic view illustrating an inkjet multi-function peripheral (MFP), and FIG. 17B is a schematic view illustrating an electrophotographic MFP.

FIG. 18 is a diagram illustrating spatial frequency characteristics of a pattern used in embedding.

FIG. 19 is a flowchart illustrating alteration detection processing.

FIG. 20 is a diagram illustrating marker regions that is used in identifying of an embedded information region according to a second exemplary embodiment.

FIG. 21 is a block diagram illustrating a mobile device according to the second exemplary embodiment.

### DESCRIPTION OF THE EMBODIMENTS

Hereinafter, exemplary embodiments will be described with reference to the drawings. The exemplary embodiments do not limit the disclosure, and all combinations of features described in the exemplary embodiments are not necessarily essential to the solving means of the present disclosure. The same components are denoted by the same reference numerals and the redundant description will be omitted. Image data representing an image may be simply referred to as an image.

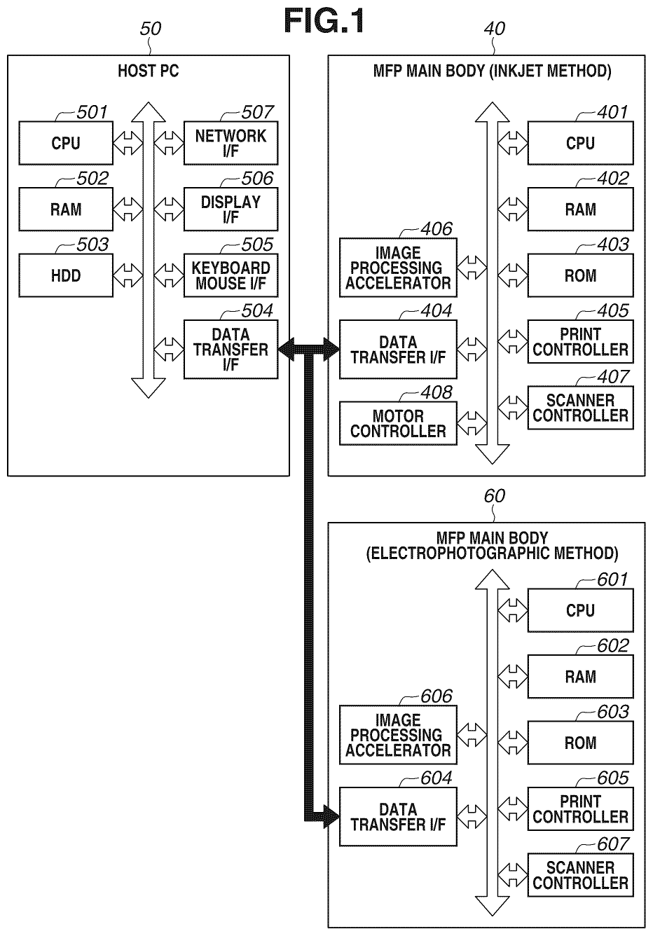

FIG. 1 is a block diagram illustrating a configuration of a printing system for printing a multiplexed document. This printing system includes an MFP main body 40 using an inkjet printing method, an MFP main body 60 using an electrophotographic printing method, and a personal computer (PC) 50 as a host apparatus (host PC). The term “MFP main body” refers to a printer including a plurality of functions, such as a printer function and a scanner function. The MFP main body may also include a copy function that is implemented in cooperation with some of the functions.

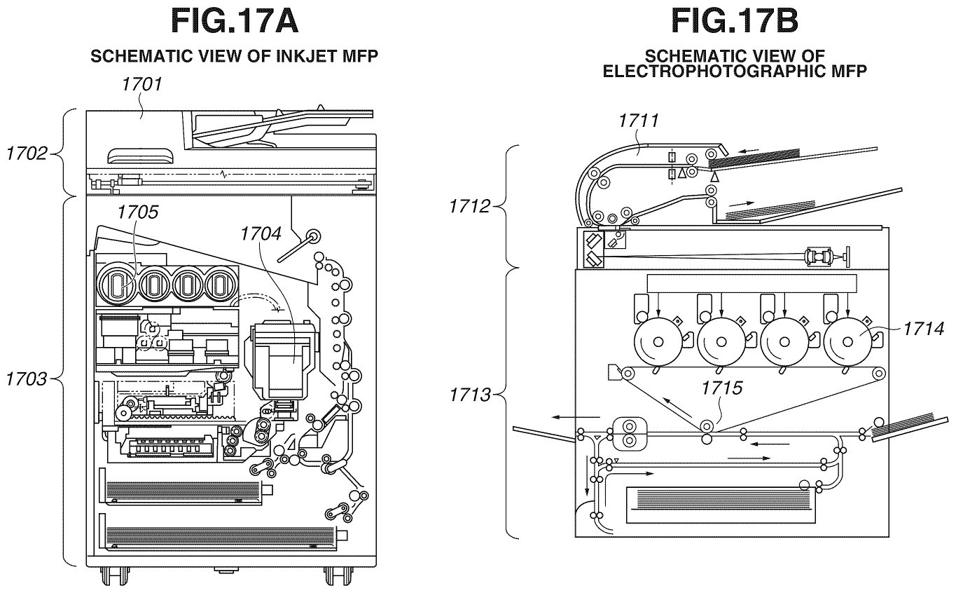

FIGS. 17A and 17B are schematic views of MFPs. FIG. 17A is a schematic view of an inkjet MFP, and FIG. 17B is a schematic view of an electrophotographic MFP. An inkjet MFP 1701 includes a scanner unit 1702 and a printing unit 1703. The printing unit 1703 includes a print head 1704 and an ink tank unit 1705. The print head 1704 discharges ink based on print data. The ink tank unit 1705 stores ink to be supplied to the print head 1704. Ink (color material) to be stored is cyan, magenta, yellow, and black ink. Ink of a particular color or the like is separately held depending on the model.

An electrophotographic MFP 1711 includes a scanner unit 1712 and a printing unit 1713. The printing unit 1713 includes photosensitive drums 1714 and a transfer roller 1715. The electrophotographic MFP 1711 includes the number of photosensitive drums 1714 corresponding to the number of colors of color materials. Each of the photosensitive drums 1714 corresponds to a different one of cyan toner, magenta toner, yellow toner, and black toner. A latent image based on print data is formed on each of the photosensitive drums 1714. The transfer roller 1715 transfers the formed latent images to a sheet conveyed as a print medium, and performs print processing on the sheet.

The host PC 50 mainly includes the following elements. A central processing unit (CPU) 501 executes processing based on programs stored in a hard disk drive (HDD) 503 and a random access memory (RAM) 502. The RAM 502 is a volatile storage and temporarily holds programs and data. The HDD 503 is a non-volatile storage and also holds programs and data. A data transfer interface (I/F) 504 controls data transmission and reception between the MFP main body 40 and the MFP main body 60. As a connection system for the data transmission and reception, a wired connection, such as a universal serial bus (USB), Institute of Electrical and Electronics Engineers (IEEE) 1394, and a local area network (LAN), and a wireless connection, such as Bluetooth® and Wi-Fi®, may be used. In a case where a print model is set using a driver during printing, a data transfer I/F is returned and print data is transmitted to the designated MFP. A keyboard mouse I/F 505 is an I/F for controlling a human interface device (HID), such as a keyboard and a mouse. A user can input information via the keyboard mouse I/F 505. A display I/F 506 controls display on a display (not illustrated). A network I/F 507 connects the host PC 50 to an external network and communicates with one or more external PCs to issue a document identification (ID) check request, a result request, a document data request, and the like.

The MFP main body 40 using an inkjet printing method as the printing method mainly includes the following elements. A CPU 401 executes processing based on programs held in a read-only memory (ROM) 403 and a RAM 402. The RAM 402 is a volatile storage and temporarily holds programs and data. The ROM 403 is a non-volatile storage and holds table data and programs to be used for processing.

A data transfer I/F 404 controls transmission and reception of data to and from the host PC 50. A print controller 405 is configured to read control parameters and recording data from a predetermined address in the RAM 402. The print controller 405 controls a print head heating operation according to recording data based on control parameters to discharge ink and perform print processing. An image processing accelerator 406 includes hardware and executes image processing at a higher speed than the CPU 401. Specifically, the image processing accelerator 406 is configured to read parameters and data for image processing from a predetermined address in the RAM 402. In response to the CPU 401 writing the parameters and data to the predetermined address in the RAM 402, the image processing accelerator 406 is activated to perform predetermined image processing. The image processing accelerator 406 is an optional element, and depending on the specifications and the like of the printer, table parameter creation processing and image processing may be executed by processing that is performed by the CPU 401.

A scanner controller 407 instructs a scanner unit (not illustrated) to transmit information about the irradiation of light on a document and the amount of reflected light obtained by an image sensor, such as a charge-coupled device (CCD) sensor, to the scanner controller 407.

Specifically, in response to the CPU 401 writing control parameters and read data write addresses to the predetermined address in the RAM 402, the scanner controller 407 starts processing. Then, the scanner controller 407 performs a light emission control operation for a light-emitting diode (LED) mounted on the scanner unit, an operation of obtaining light amount information from the scanner unit, and an operation of writing light amount information to the read data write address and the subsequent addresses in the RAM 402.

A motor controller 408 controls a motor operation for a plurality of motor units (not illustrated). The motors are used to cause the above-described print head to move relative to a recording sheet and to cause the scanner unit to move relatively to a document to be scanned. In addition, some MFPs may include a motor for maintenance of the print head.

The MFP main body 60 using an electrophotographic printing method has a configuration similar to that of the inkjet MFP main body 40. The MFP main body 60 differs from the MFP main body 40 in regard to a printing device portion. A print controller 605 develops and transfers an image corresponding to print data on a drum surface, based on a control parameter obtained from a predetermined address in a RAM 602, whereby print processing is performed. Redundant descriptions of a CPU 601, the RAM 602, a ROM 603, an image processing accelerator 606, a data transfer I/F 604, and a scanner controller 607 included in the MFP main body 60 are omitted.

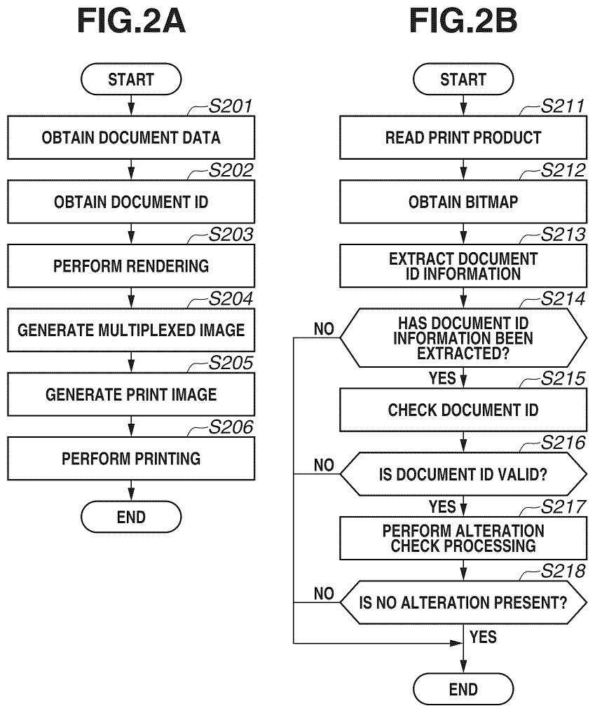

FIG. 2A is a flowchart illustrating authentic document ID information embedding processing, and FIG. 2B is a flowchart illustrating extraction processing, according to a first exemplary embodiment. In the flowchart illustrated in FIG. 2A, steps S201 to S206 correspond to the authentic document ID information embedding processing flow, and in the flowchart illustrated in FIG. 2B, steps S211 to S218 correspond to the authentic document ID information extraction flow.

Inkjet recording processing will now be described, and the authentic document ID information embedding processing will be described.

In step S201, the host PC 50 obtains document data. Specifically, in the present exemplary embodiment, the host PC 50 connects to an external PC via the network I/F 507, issues a request for document data, and obtains the document data.

The document data is described using a page description language (PDL). A PDL is composed of a pair of rendering commands per page. The type of each rendering command is defined based on the specifications of each PDL. In the present exemplary embodiment, for example, the following three types are mainly used.

Command 1) Text rendering command (X1, Y1, color, font information, character string information)
Command 2) Box rendering command (X1, Y1, X2, Y2, color, coating shape)
Command 3) Image rendering command (X1, Y1, X2, Y2, image file information)

In addition to the above commands, rendering commands, such as a dot rendering command for rendering a dot, a line rendering command for rendering a line, and a circle rendering command for rendering a circle, are used as appropriate based on the intended use.

Examples of PDL generally used include a portable document format (PDF) proposed by Adobe Inc., Extensible Markup Language (XML) Paper Specification (XPS) proposed by Microsoft Corporation, and Hewlett-Packard Graphics Language (HP-GL)/2 proposed by Hewlett-Packard Company. The application range of embodiments of the present disclosure is not limited to these example.

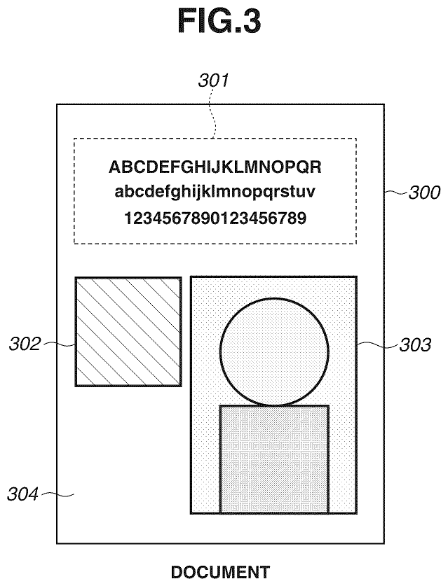

FIG. 3 is a diagram illustrating an example of document data. A document 300 represents one page document data which includes 600 pixels in width and 900 pixels in height.

An example of PDL corresponding to the document data illustrated in FIG. 3 is described below.

<PAGE=001>
<TEXT> 50, 50, 550, 100, BLACK, STD-18, “ABCDEFGHIJKLMNOPQR” </TEXT>
<TEXT> 50, 100, 550, 150, BLACK, STD-18, “abcdefghijklmnopqrstuv” </TEXT>
<TEXT> 50, 150, 550, 200, BLACK, STD-18, “1234567890123456789” </TEXT>
<BOX> 50, 300, 200, 450, GRAY, STRIPE </BOX>
<IMAGE> 250, 300, 550, 850, “PORTRAIT.jpg” </IMAGE>
</PAGE>

<PAGE-001> in the first line is a tag representing the number of pages in the present exemplary embodiment. A normal PDL is designed to describe a plurality of pages, and thus tags each indicating a page partition in the PDL. In the present exemplary embodiment, the PDL expresses that a portion up to </PAGE> in the tenth line corresponds to the first page, and also corresponds to the document 300 illustrated in FIG. 3. If there is a second page, <PAGE=002> is written subsequent to the above-described PDL.

A portion from <TEXT> in the second line to </TEXT> in the third line is a rendering command 1 and corresponds to the first line of a text portion 301. The first two coordinates indicate coordinates (X1, Y1) that are an upper left corner of a rendering region, and the subsequent two coordinates indicate coordinates (X2, Y2) that are a lower right corner of the rendering region. The rendering command 1 describes that the color is BLACK (black color: R=0, G=0, B=0), the font of the text is “STD” (standard), the text size is 18 points, and the text string to be written is “ABCDEFGHIJKLMNOPQR”.

A portion from <TEXT> in the fourth line to </TEXT> in the fifth line is a rendering command 2 and corresponds to the second line of the text portion 301. The first four coordinates and the two text strings express the rendering region, the font color, and the font of the text as in the rendering command 1. Further, the rendering command 2 describes that the text string to be written is “abcdefghijklmnopqrstuv”.

A portion from <TEXT> in the sixth line to </TEXT> in the seventh line is a rendering command 3 and corresponds to the third line of the text portion 301. The first four coordinates and the two text strings express the rendering region, the font color, and the font of the texts as in the rendering commands 1 and 2. Further, the rendering command 3 describes that the text string to be written is “1234567890123456789”.

A portion from <BOX> to </BOX> in the eighth line is a rendering command 4 and corresponds to a rectangle rendering portion 302. The first two coordinates indicate upper left coordinates (X1, Y1) as a rendering start point, and the subsequent two coordinates indicate lower right coordinates (X2, Y2) as a rendering end point. The color is specified to be GRAY (gray color: R=128, G=128, B=128), and the fill pattern is specified to be STRIPE (stripe pattern) that is a stripe pattern. While, in the present exemplary embodiment, regarding the direction of the stripe pattern, the stripe pattern has lines extending in a direction toward the lower right side, the configuration may be such that the angle, cycle, and the like of the lines are specified in the box rendering command.

An image rendering command in the ninth line corresponds to an image portion 303. In this case, the image rendering command describes that a file name of an image in this region is “PORTRAIT.jpg”. This expresses that the image is a file of Joint Photographic Experts Group (JPEG) that is a widely-used image compression format.

Further, </PAGE> written in the tenth line describes that the rendering for this page is completed.

In many cases, an actual PDL file is a file integrally including the “STD” font data and the “PORTRAIT.jpg” image file in addition to the rendering command set described above. This is because, in a case where the font data and the image file are separately managed, formation of the text portion and the image portion may be failed with the rendering commands, and information is insufficient for forming the image illustrated in FIG. 3.

The above description is of the document data obtained in step S201 illustrated in FIG. 2A.

In step S202, the host PC 50 obtains the document ID indicating the authenticity of the document data obtained in step S201. This is information calculated based on all document files, including the above-described PDL file, font data, and image files, and is 128-bit information in the present exemplary embodiment. This document ID information calculation method is designed such that, in a case where any of the files forming the document is changed, the calculated document ID has a different value. Accordingly, a unique document ID corresponds to the document file. Specifically, in the present exemplary embodiment, the host PC 50 requests the external PC that has obtained the document file in step S202 to obtain the document ID, and receives the document ID.

Another implementation method may be a configuration such as a blockchain in which the document data and the document ID are managed in a plurality of external PCs and the host PC 50 requests the plurality of PCs to obtain the document ID. With this configuration, an alteration risk of the document ID itself is reduced.

Next, in step S203, the host PC 50 performs rendering processing on the document data obtained in step S201. The rendering processing is a step of executing the rendering commands described in the PDL and forming a bitmap image composed of color information of each pixel.

In the present exemplary embodiment, since the document 300 illustrated in FIG. 3 has the horizontal width of 600 pixels and the vertical width of 900 pixels as described above, the bitmap image generated in this step is an image formed of 600×900 pixels. Each pixel of the bitmap image is expressed in 256 levels of 8 bits for each of red (R), green (G), and blue (B).

In step S204, the host PC 50 creates a multiplexed image.

The multiplexed image is obtained by superimposing the document ID information obtained in step S202 on the rendering image generated in step S203. This processing is performed to allow, in the case of scanning an output product obtained by printing the superimposed images by a copying machine, the document ID to be extracted from the scanned document in the copying machine. Also, this processing is performed to allow the determination of whether the output product itself is based on the digital document managed by the document ID to be performed.

Processing of superimposing additional information such as document ID information on the rendering image to generate a multiplexed image is also referred to as a multiplexing encoding processing. The multiplexing encoding processing will be described in detail below.

In step S205, the host PC 50 generates a print image. Any known method may be used to generate a print image. The present exemplary embodiment illustrates an example where the following method using an inkjet method is used.

In the present exemplary embodiment, four processes, that is, color conversion processing, ink color separation processing, output characteristic conversion processing, and quantization processing, are performed on each pixel of the multiplexed bitmap image formed of RGB pixel values generated in step S204.

The color conversion processing is a process of converting RGB information about the multiplied bitmap image so that the RGB information is appropriately printed by the MFP main body 40. The reason of performing the processing is that, in general, a color value to be suitably expressed on the display is set for a color described in a PDL rendering command, and if the value is directly output from a printer, a different color may be output.

Specifically, with respect to a combination of input pixel values (Rin, Gin, Bin), a three-dimensional look-up table is used to calculate a suitable combination of output pixel values (Rout, Gout, Bout). Ideally, since each of input values Rin, Gin, and Bin has 256 levels, a table Table1 [256] [256] [256] [3] having 256×256×256, that is, a total of 16,777,216 combinations of output values, is prepared. Then, the color conversion processing is implemented by setting the values as follows.
Rout=Table1[Rin][Gin][Bin][0]
Gout=Table1[Rin][Gin][Bin][1]
Bout=Table1[Rin][Gin][Bin][2]
   Alternatively, a technique for reducing the table size, for example, is used to reduce the number of grids in the look-up table from 256 grids to, for example, 16 grids or the like, and the output values are determined by interpolating table values of multiple grids.

The ink color separation processing is a process of converting Rout, Gout, and Bout, which are the output values of the color conversion processing, into output values of the respective ink colors for inkjet recording. In the present exemplary embodiment, an inkjet method using four ink colors of cyan, magenta, yellow, and black is used. Although there are various implementation methods for conversion, in the present exemplary embodiment, like in the color conversion processing, a suitable combination of ink color pixel values (C, M, Y, K) is calculated for a combination of output pixel values (Rout, Gout, Bout). A three-dimensional look-up table Table2[256][256][256][4] is used. That is, the ink color separation processing is implemented by setting the following values.
C=Table2[Rout][Gout][Bout][0]
M=Table2[Rout][Gout][Bout][1]
Y=Table2[Rout][Gout][Bout][2]
K=Table2[Rout][Gout][Bout][3]
   A known technique for reducing the table size may be used.

The output characteristic conversion processing is a process of converting the density of each ink color into a print dot count ratio. Specifically, for example, 256-level densities of the respective colors are converted into 1024-level dot count ratios Cout, Mout, Yout, and Kout of the respective colors. To implement this, a one-dimensional look-up table Table3[4][256] in which suitable print dot count ratios are set with respect to the densities of the respective ink colors is used. Then, the output characteristic conversion processing is implemented by setting the following values.
Cout=Table3[0][C]
Mout=Table3[1][M]
Yout=Table3 [2] [Y]
Kout=Table3[3][K]
   Also, a technique for reducing the table size, for example, may be used to reduce the number of grids in the look-up table from 256 grids to, for example, 16 grids or the like, and the output values are determined by interpolating table values of multiple grids.

The quantization processing is a process of converting each of the print dot count ratios Cout, Mout, Yout, and Kout of the respective ink colors to a value indicating an actual ON or OFF of a print dot in each pixel. Any method, such as an error diffusion method or a dither method, may be used as the quantization method. For example, in the dither method, ON or OFF of the print dots of the respective ink colors is implemented by setting the following values:
Cdot=Halftone[Cout][x][y],
Mdot=Halftone[Mout][x][y],
Ydot=Halftone[Yout][x][y], and
Kdot=Halftone[Kout][x][y],
   and comparing the values with a threshold corresponding to each pixel position. Occurrence probabilities of the respective print dots are Cout/1023, Mout/1023, Yout/1023, and Kout/1023.

In the above-described way, the print image generation processing in step S205 is completed. The generated print image is transmitted to the inkjet MFP main body 40, and the print processing of the print image is performed.

In step S206, the MFP main body 40 prints the print image generated in step S205.

The document based on document data in which document ID information is embedded is printed on a print medium. (multiplexing Encoding Processing)

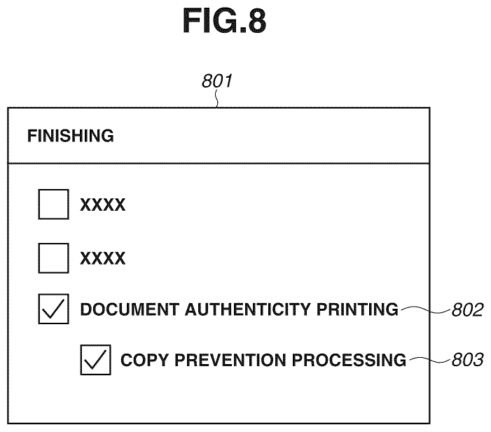

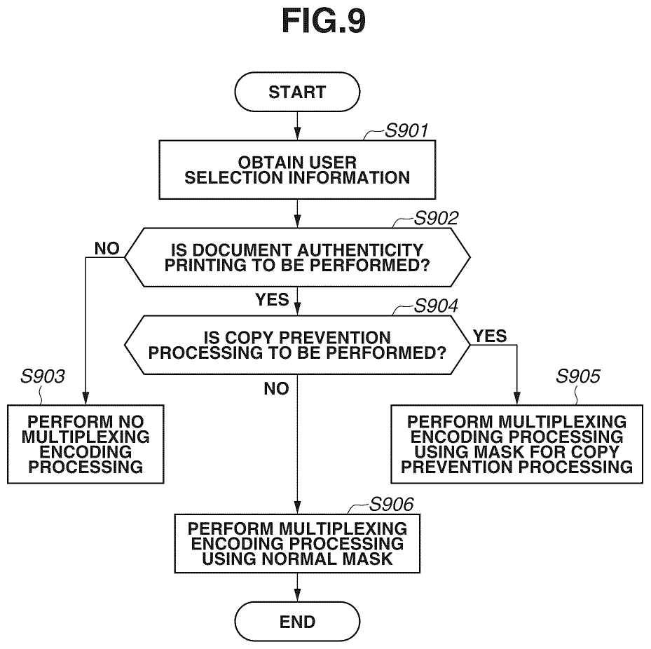

The multiplexing encoding processing for generating a multiplexed image using the rendering image in step S204 will be described in detail with reference to FIGS. 8 and 9.

In step S901, a user interface (UI) screen 801 as illustrated in FIG. 8 is presented to the user before the user issues a print start instruction via a printer driver or the like, and information indicating whether the user has checked one of a document authenticity printing checkbox 802 and a copy prevention processing checkbox 803.

In step S902, based on the information obtained in step S901, determination of whether document authenticity printing is to be performed is performed. In a case where it is determined that document authenticity printing is not to be performed (NO in step S902), the processing proceeds to step S903. In a case where it is determined that document authenticity printing is to be performed (YES in step S902), the processing proceeds to step S904. In step S904, determination of whether copy prevention processing is to be performed is performed. Unless the user selects or checks the document authenticity printing checkbox 802, the copy prevention processing checkbox 803 will not be selectable.

In step S903, the document ID is not embedded in the bitmap image obtained by the rendering processing in step S203, and then the processing proceeds to step S205 to generate a print image.

In step S906, the multiplexing encoding processing is performed using a normal mask. The document ID will now be described. The document ID is binary data. Handling information on an information processing apparatus, such as a PC, means handling binary data. Binary data is information represented using values “0” and “1”, and information of this “0” or “1” is connected in a sequence and has a specific meaning. For example, in a case of handling information indicating “hello” with binary data in, for example, Shift Japanese Industrial Standards (JIS), which is one of character encoding schemes, the alphabetical character “h” corresponds to binary data “01101000”. Similarly, “e” corresponds to binary data “01100101”, “1” corresponds to binary data “01101100”, and “o” corresponds to binary data “01101111”. That is, the character string “hello” can be expressed with binary data “0110100001100101011011000110110001101111”. Thus, in a case where binary data “0110100001100101011011000110110001101111” is obtained, the character string “hello” is obtained. Based on this idea, multiplexing is implemented by embedding predetermined data in such a manner that “0” or “1” is to be distinguishable.

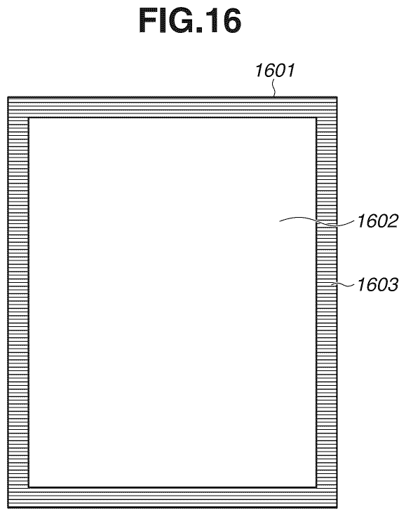

FIG. 16 is a diagram illustrating a region of a bitmap image on which document ID information is to be superimposed. In the case of extracting embedded data from the multiplexed document, the region in which the document ID information is embedded is identified using a marker. Thus, a region in which the document ID information is embedded and a marker region to identify the region are set on the bitmap image to be used when the document is printed, and the multiplexing processing is executed on the region and the marker region. An entire bitmap image 1601 to be multiplexed includes an information portion 1602 as a region in which document ID information is embedded in the print region, and a marker portion 1603 as a region in which a marker is embedded in the document.

To simplify the description, the marker portion 1603 is set to surround the information portion 1602 and the entire portion of the document is multiplexed, unlike the information portion 1602. The marker portion 1603 may be set at an end that is a part of the information portion 1602. Examples of the end include an upper end and a left end of the information portion 1602. The end may be a part of the upper right end portion of the information portion 1602. The end may exclude an outermost end portion, and may be on the inside of the outermost end portion.

### (Multiplexing Encoding Processing Using Normal Mask)

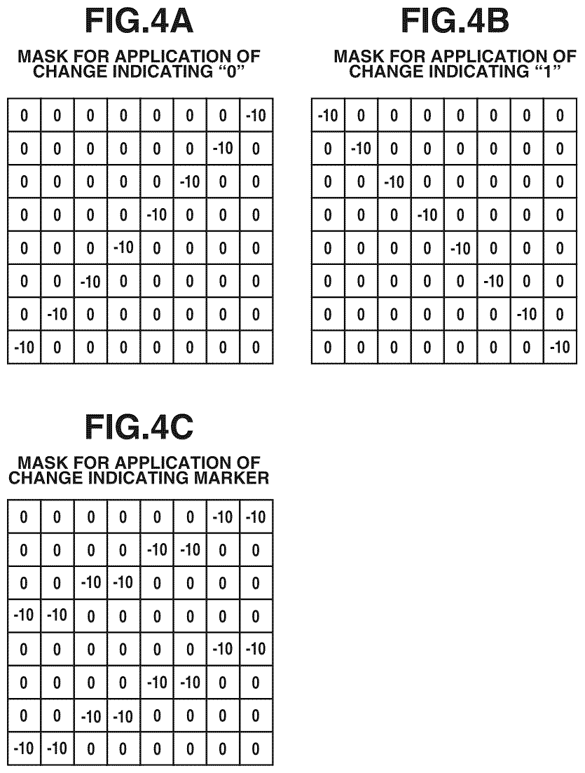

Two masks (first predetermined pattern) illustrated in FIGS. 4A and 4B are used to superimpose “0” or “1” within an image, and a mask (second predetermined pattern) illustrated in FIG. 4C is used to superimpose a marker. The masks illustrated in FIGS. 4A and 4B are used to embed information, and the mask illustrated in FIG. 4C is used to embed a marker for the position of an information portion (information region) to be identified in extraction.

Each mask is formed of 8 pixels×8 pixels, and a cyclic pattern is given to a region of 8 pixels×8 pixels within the image by adding the content of the mask to the image, in other words, by changing the density of print data. A digital image is basically expressed with 8 bits per color, and any one of values “0” to “255” is assigned to the digital image. Values that fall outside of this range cannot be used for image data. Thus, in a case where the calculation result of pixel values is less than “0” or more than or equal to “256”, the value “0” or “255” is generally assigned to set the value within an effective range. The masks illustrated in FIGS. 4A and 4B give a change of “−10” or “0”. In a case where the values of image data in the mask region are all “0”, the values in that region are not “−10” or “0”, but are all “0”. The same holds true for the mask illustrated in FIG. 4C. While the case of using 8 bits per color is described in the present exemplary embodiment, the number of bits other than 8 bits may be used. In the case of digital image processing, an effective range is set regardless of the number of bits to be used to express the image, and application of such a change as to bring pixel values outside the range is not performed.

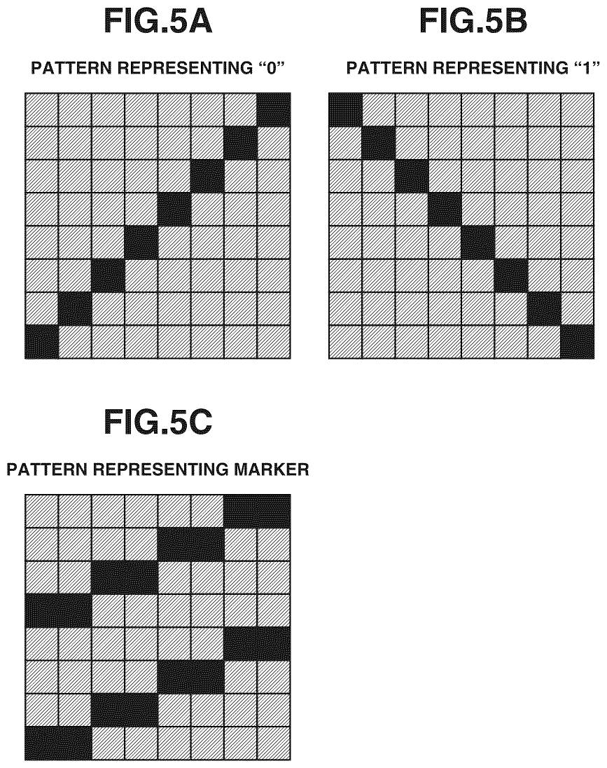

FIGS. 5A to 5C visually illustrate patterns to be formed in images with the masks illustrated in FIGS. 4A to 4C, respectively. In the masks illustrated in FIGS. 4A to 4C, the positions of “−10” are indicated by black and the positions of “O” are indicated by hatching. An oblique line as illustrated in FIGS. 5A to 5C appears in the image.

In the marker portion 1603, the width corresponding to two blocks of the mask (corresponding to 16 pixels) is secured and embedding processing is performed on the region using a marker mask. In the information portion 1602, the mask illustrated in FIG. 4A and the mask illustrated in FIG. 4B are switched based on binary values of the document ID information, and the embedding processing is performed on the set information portion region. The following represents pseudocode by which the pattern is switched between the information portion (information region) and the marker portion (marker region).

| | |
|---|---|
| 01: | int i, j, k, l; |
| 02: | int width = 600, height = 900; |
| 03: | unsigned char *data = image data; |
| 04: | int** Mask0 = mask data (Fig. 4A); |
| 05: | int** Mask1 = mask data (Fig. 4B); |
| 06: | int** Marker = mask data (Fig. 4C); |
| 07: | int** switchingMask = mask switching data (Fig. 16); |
| 08: | for (j = 0; j < height; j+ = 8){ |
| 09: | for (i = 0; i < width; i+ = 8){ |
| 10: | for (k = 0; k < 8; k++){ |
| 11: | for (l = 0; l < 8; l++){ |
| 12: | if (switchingMask[(i + k) + (j + l)*width] = = 0){ |
| 13: | data[ (i + k) + (j + l)*width] + = Mask0[k][l]; |
| 14: | } |
| 15: | else if (switchingMask[ (i + k) + |
| | (j + l)*width] = = 1){ |
| 16: | data[ (i + k) + (j + l)*width] + = Mask1[k][l]; |
| 17: | } |
| 18: | else if (switchingMask[(i + k) + |
| | (j + l)*width] = = −1){ |
| 19: | data[ (i + k) + (j + l)*width] + = Marker[k][l]; |
| 20: | } |
| 21: | } |
| 22: | } |
| 23: | } |
| 24: | } |

The processing of each program will be described below.

In the line 02, the width and height of the bit map image on which the multiplexing processing is performed are set with the number of pixels. In the line 03, an initial address where the bitmap image on which the multiplexing processing is performed is loaded into a memory region is set.

In the line 04, an initial address where the mask indicating binary data “O” is held in the memory region is set. Similarly, in the line 05, an initial address where the mask indicating binary data “1” is held is set, and in the 06 line, an initial address where the mask indicating the marker is held is set.

In the line 07, data storing switching of the mask to be used is set. As the mask switching data, the mask to be used is set for each pixel based on the information portion and the marker portion specified in FIG. 16. With respect to pixels in which binary data “0” is embedded within the information portion region, “0” is set as the mask switching data. With respect to pixels in which binary data “1” is embedded, “1” is set as the mask switching data. For the marker portion, “−1” is set as the mask switching data. An initial address where these pieces of set mask switching data are loaded into the memory region is set.

In the lines 08 and 09, a loop of coordinate positions where processes are sequentially performed on the bitmap image is set. The processing is incremented every eight pixels. This is because the processing corresponding to the size of the mask to be used is skipped.

In the lines 10 and 11, the processing is performed in units of pixels based on the mask size. In the lines 12, 15, and 18, processing coordinates are calculated based on i, j, k, and l, and determination of whether conditions are satisfied is performed with reference to the mask switching data in the coordinates. In a case where the result of the reference indicates “0”, the processing proceeds to the line 13. Then, a change value of the mask (a) is obtained based on k and l, and the change value is overwritten with the sum of the obtained value and the pixel value in the target coordinates of the bitmap image. In a case where the result of reference indicates a value other than “0”, the processing proceeds to the line 15.

In the line 15, in a case where the result of referring to the mask switching data indicates “1”, the processing proceeds to the line 16. Then, a change value of the mask (b) is obtained based on k and l, and the change value is overwritten with the sum of the obtained value and the pixel value in the target coordinates of the bitmap image. In a case where the result of the reference indicates a value other than “1”, the processing proceeds to the line 18.

In the line 18, in a case where the result of referring to the mask switching data indicates “−1”, the processing proceeds to the line 19. Then, a change value of the mask (c) for the marker is obtained based on k and l, and the change value is overwritten with the sum of the obtained value and the pixel value in the target coordinates of the bitmap image.

This series of processes is performed until the loop of i and j is completed.

In the present exemplary embodiment, the above-described embedding processing is performed on the B pixel values among the RGB pixel values illustrated in FIGS. 4A to 4C. This is because, in the case of performing printing on a white paper portion 304 with ink, Y ink is a high lightness component, and thus the visibility of Y ink is lower than that of the other inks such as C ink, M ink, and K ink.

The embedded information is desirably as less visible as possible so as not to affect the original document information. Accordingly, control is performed to modulate the B pixel values to set the change of Y ink to be greatest.

While the present exemplary embodiment illustrates an example where one type of mask is used as a mask for a marker, two or more types of masks may be prepared and embedded in the marker region. For example, an inclination that occurs during scanning of a document may be corrected using two types of masks in combination. In other words, a frequency analysis is performed while the angle is adjusted during the extraction processing, so that the angle when two types of peaks appear in a preliminarily set frequency band can be determined to be a correction angle.

While the present exemplary embodiment described above illustrates an example where the size of the mask for the marker is the same as the size of the mask for embedding information, these masks may have different sizes. For example, the size of the mask for the marker portion may be twice the size of the mask for the information portion. As a result, a position search is performed with a low resolution, which leads to a reduction in time to be taken to identify the information portion.

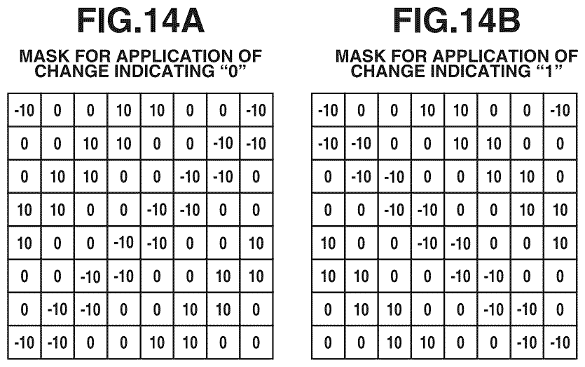

In a document according to the present exemplary embodiment, the white paper portion 304 is sufficiently large, and in the document 300, a portion other than the text portion 301, the rectangle rendering portion 302, and the image portion 303 corresponds to the white paper portion 304. However, in the case of embedding the information portion 1602, information may be insufficiently embedded in the portion other than the white paper portion 304 with the masks illustrated in FIGS. 4A to 4C in some cases. For example, the processing result for the masks illustrated in FIGS. 4A to 4C is the same black (R=0, G=0, B=0) with respect to black (R=0, G=0, B=0). Therefore, in the case of embedding information in the portion other than the white paper portion 304, in particular, in the image portion or the like, the masks as illustrated in FIGS. 14A and 14B may be desirably used. While the present exemplary embodiment illustrates an example where the embedding processing is performed on the information portion other than the marker portion, the embedding processing is also performed on the marker portion in the same manner.

In the masks illustrated in FIGS. 14A and 14B, changes of −10″, “0”, and “+10” are applied to pixel values.

In this case, in a case where the values of the image data in the mask region are all “O”, the values in the region are “−10”, “0”, and “+10”, so that the values become “0” and “+10”. In other words, the information embedding processing is performed on all pixel values with a pattern of applying both a change for increasing a pixel value and a change for decreasing a pixel value.

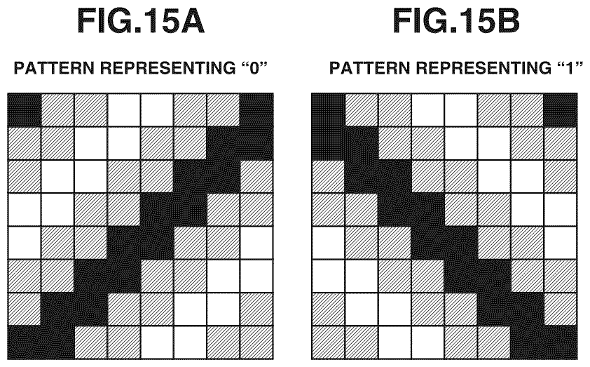

FIGS. 15A and 15B visually illustrate patterns to be applied on an image with the mask for the image portion. In the masks illustrated in FIGS. 14A and 14B, the positions of “−10” are indicated by black, the positions of “0” are indicated by hatching, and the positions of “10” are indicated by white. An oblique line as illustrated in FIGS. 15A and 15B appears in the image.

In the present exemplary embodiment described above, it is desirable to use the masks illustrated in FIGS. 14A and 14B for the image portion 303 illustrated in FIG. 3. Similarly, the masks illustrated in FIGS. 4A and 4B are used because the proportion of the white paper portion 304 is generally likely to be large in the text portion 301 and the rectangle rendering portion 302.

However, in some cases, it may be desirable to apply the masks illustrated in FIGS. 14A and 14B to the text portion 301 and the rectangle rendering portion 302 depending on the color, the width of characters, and the like. Even an image rendering portion is sometimes extremely similar to the white paper portion 304. For this reason, to more reliably realize the embedding processing, it is desirable to determine which one of the masks illustrated in FIGS. 14A and 14B is used, for example, by obtaining a density histogram on each region.

(Multiplexing Processing with Mask for Copy Prevention Processing)

While the multiplexing encoding processing with a normal mask in step S906 is described above, differences between the multiplexing encoding processing in step S906 and the multiplexing encoding processing with the mask for the copy prevention processing in step S905 will be mainly described.

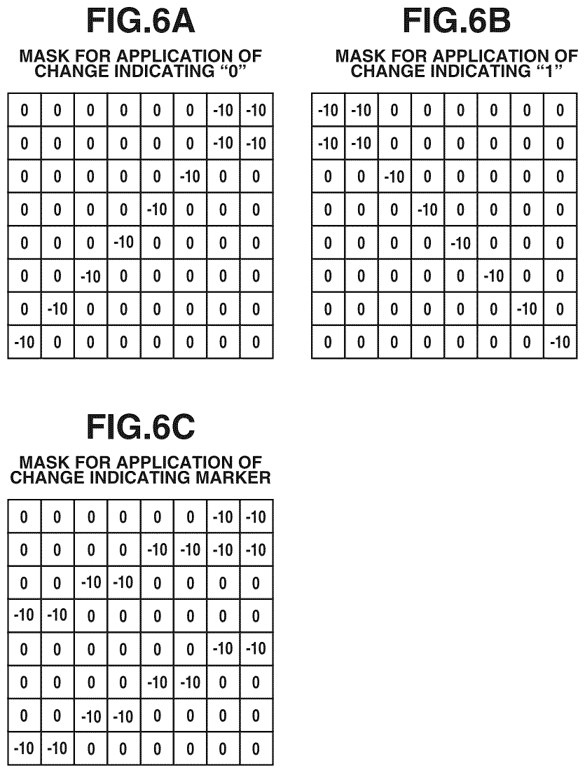

Two masks illustrated in FIGS. 6A and 6B are used to superimpose “0” and “1” within the image as the mask for the copy prevention processing, and a mask illustrated in FIG. 6C is used to superimpose a marker. The masks illustrated in FIGS. 6A and 6B are used to embed information, and the mask illustrated in FIG. 6C is used to embed the marker for the position of the information portion to be identified in extraction of the embedded information.

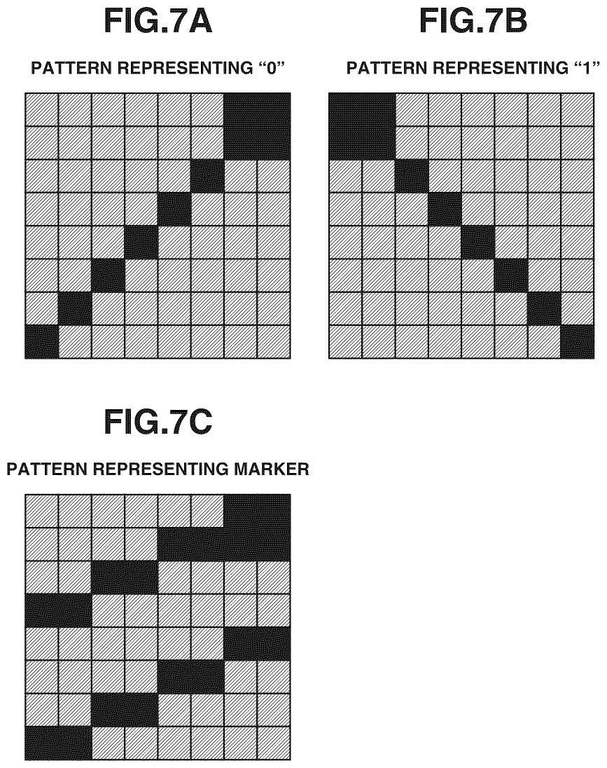

FIGS. 7A to 7C visually illustrate patterns to be applied on images with the masks illustrated in FIGS. 6A to 6C, respectively. In the masks illustrated in FIGS. 6A to 6C, the positions of “−10” are indicated by black, and the positions of “O” are indicated by hatching. An oblique line as illustrated in FIGS. 7A to 7C appears in the image.

Like in FIGS. 4A to 4C, a change of “−10” or “0” is applied to pixel values of “0” of “255” on image data. This differs from a normal mask in that two pixels “−10” are added to each of the upper right portion in FIG. 6A, the upper left portion in FIG. 6B, and the upper right portion in FIG. 6C. Referring to FIGS. 7A to 7C, the shape of a part of the oblique line indicated by black within the same region of the mask is larger than that in the other region of the oblique line.

In a print product obtained by printing a multiplexed image in which the masks illustrated in FIGS. 6A to 6C are reflected, as typical characteristics, dots formed by aggregation of pixels are more likely to remain due to degradation in the characteristics of a modulation transfer function (MTF) during scanning by a copying machine and image processing, such as background color removal, so that thin lines or isolated dots are more likely to disappear. For this reason, dots formed by four pixels as illustrated in FIGS. 7A to 7C before and after a copying processing by the copying machine are more likely to remain as compared with the other pixels. As a result, the cycle and peak direction of the frequency change, which leads to the difficulty in extraction of additional information.

After the copying processing is repeatedly performed by the copying machine, the shape expressed with a mask progresses. For example, to prevent additional information from being read in the second scanning process, it may be desirable to adjust the embedding strength for multiplexing in accordance with the content of image processing and the deterioration in MTF characteristics during printing using an intended print device and during scanning using a copying machine.

Specifically, the mask value may be changed from “−10” to “−20”, and the number of pixels “−10” for the mask may be increased or decreased. The strength may be increased by changing the plane to which the mask is applied from the B plane to RGB planes. The mask may be applied not only to lightness, but also to saturation.

In the present exemplary embodiment, the mask for the copy prevention processing is applied to both the marker portion and the information portion, but instead may be applied to only one of the marker portion and the information portion. In a case where the mask for the copy prevention processing is applied to the marker portion, the position of the marker is unidentifiable in extraction of the document ID after copying. In a case where the mask for the copy prevention processing is applied to the information portion, the document ID itself is unreadable. Accordingly, in both cases, the document ID is not accurately extracted.

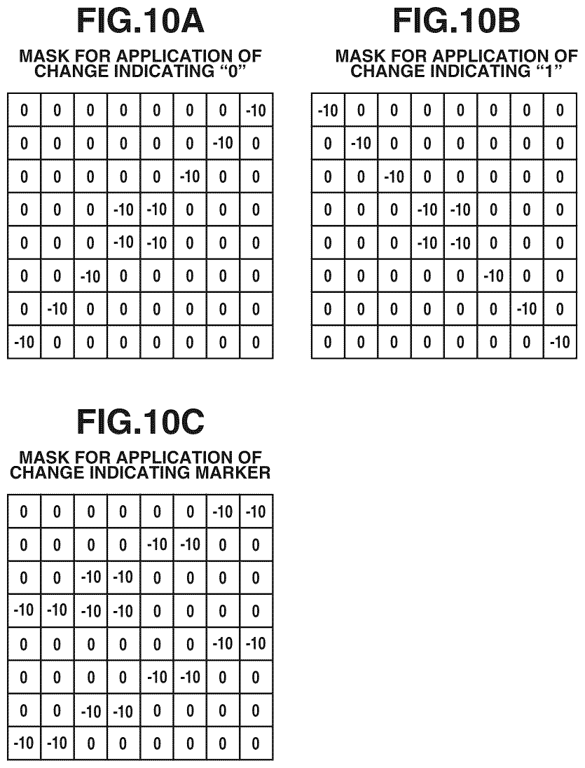

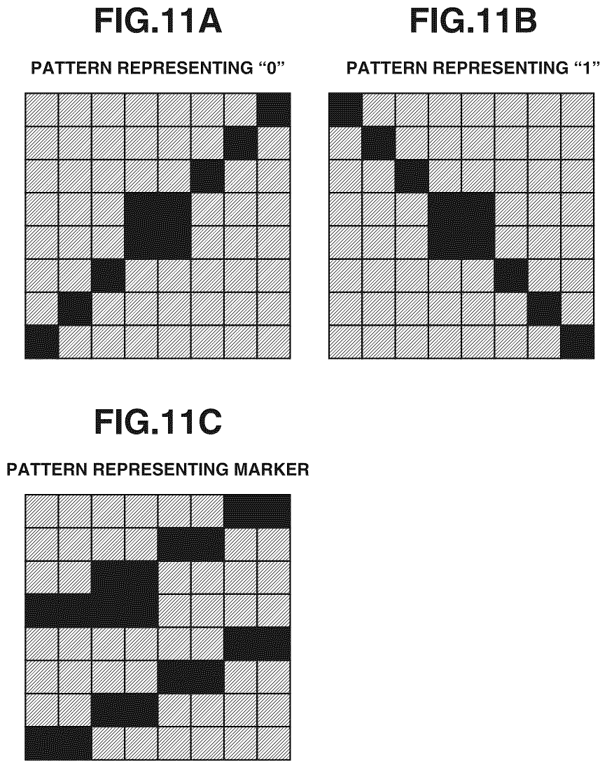

FIGS. 10A to 10C and FIGS. 11A to 11C are diagrams illustrating a modified example of the mask for the copy prevention processing. In the modified example, a pixel aggregation portion is in a region close to the center. In an example illustrated in FIG. 10C, two lines are at an equal distance from the center, and thus the aggregation portion is on the upper left line. With the aggregation portion in the vicinity of the center, a change of the pattern as illustrated in FIGS. 10A and 10B is less likely to affect the frequency peak direction. Further, the aggregation portions in the adjacent patterns are held at a certain distance, which has less visual influence.

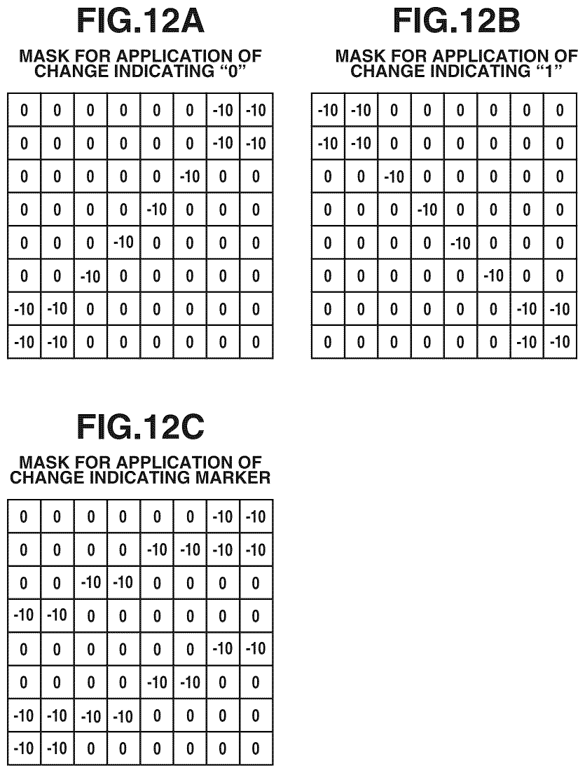

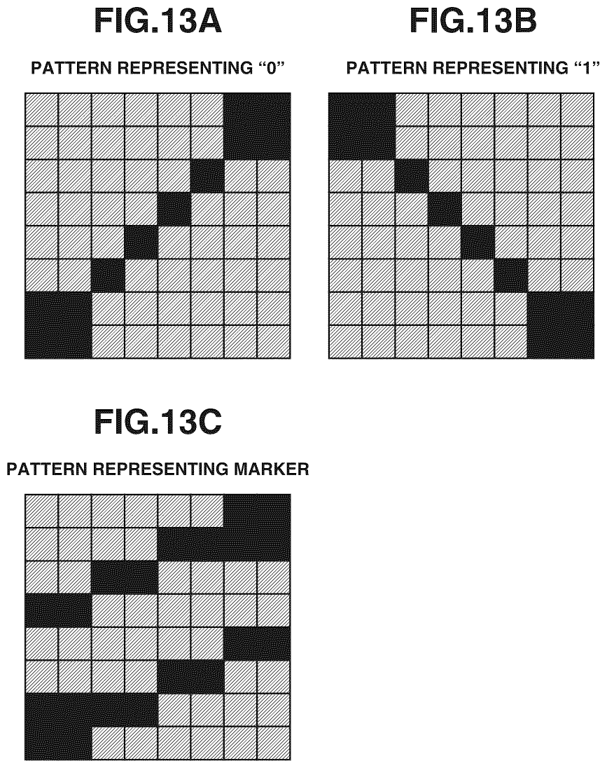

FIGS. 12A to 12C and FIGS. 13A to 13C are diagrams illustrating another modified example of the mask for the copy prevention processing. In the masks, two aggregation portions are formed within one mask. This configuration increases the effect of the copy prevention processing compared to a configuration in which one aggregation portion is formed within one mask. In some of the adjacent patterns, an aggregation portion of 16 pixels at maximum may be formed, which increases the effect of the copy prevention processing. In this case, however, the aggregation portion is visually noticeable, and thus the pattern may be desirably used depending on the intended use or purpose.

### (Large Dot, Small Dot)

While the present exemplary embodiment described above illustrates an example where dots to express colors on a print product have the same size, dots having different sizes may also be used. For example, some systems using inkjet method include an inkjet head with a large ink droplet size and a small ink droplet size. Positional information about a four-pixel aggregation portion may be held as attribute information, and when ink color data is obtained after the quantization processing, the aggregation portion may be expressed with large-size ink dots, and the other portion may be expressed with small-size ink dots.

The coverage of ink on a sheet increases when a color is expressed with large-size ink dots, which further increases the effect of copy prevention.

(Changing of Multiplexing Embedding Processing in Accordance with Printing Method)

While the present exemplary embodiment described above illustrates a processing flow of printing a multiplexed image using an inkjet method, a processing flow of printing a multiplexed image using an electrophotographic method may be employed.

Color development characteristics on a printed document obtained by the inkjet method are different from those on a printed document obtained by the electrophotographic method. In general, the color development performance on plain paper by the electrophotographic method is higher than that by the inkjet method, and the visibility of color by the electrophotographic method is higher than that by the inkjet method. Accordingly, it may be desirable to perform the multiplexing processing in such a manner that the frequency intensity in the electrophotographic method is lower than that in the inkjet method so as to obtain the same effects using the two different methods.

Specifically, a pattern with a nine-pixel aggregation portion (not illustrated) by increasing the number of aggregation portions as in the patterns illustrated in FIGS. 7A to 7C and FIGS. 13A to 13C, or by further increasing the aggregation portions illustrated in FIGS. 7A to 7C may be used.

While the present exemplary embodiment described above illustrates an example where the B pixel values among the RGB pixel values are modulated, a method for modulating CMYK pixel values may be used. In this case, the white paper is Y=0, M=0, C=0, and K=0, and the modulation with respect to the white paper may desirably take a positive value. Thus, the signs of the modulation values illustrated in FIGS. 4A to 4C and FIGS. 6A to 6C are inverted. Specifically, the modulation value of “−10” is inverted to “+10” and the modulation value of “+10” is inverted to “−10”. The same holds true for the other numerical values.

With the method in which the modulation is performed on the CMYK pixel values, controllability in the case where the ink to be applied to white paper is limited only to the Y ink is high. With the method in which the modulation is performed on the RGB pixel values, controllability of suppressing changes in hues in the case where information is embedded in the image portion is high. Accordingly, it is desirable to select a suitable modulation method in accordance with the ratios of white paper, character, and image regions in the document, and the like.

In a case where the connected printing apparatus is a system using other than a predetermined method (method other than the inkjet method and the electrophotographic method in the present exemplary embodiment), the following procedures may be desirably employed.

Procedure 1: In a case where a correction method exclusively for the printing system, such as a modulation intensity, is set, the setting is used.
Procedure 2: In a case where no dedicated settings are set, or in a case where an alternative setting is set, the alternate setting is used.

For example, an embedding setting for the electrophotographic method is highly likely usable as an alternative setting for a system using a heat-sensitive method that uses heat-sensitive paper on which colors are changed by heat. Similarly, an embedding setting for the electrophotographic method is also highly likely usable for a system using a thermal transfer method that uses an ink ribbon instead of heat-sensitive paper. In a case where a system using the inkjet method and a system using the electrophotographic method are not connected and a printing apparatus using the heat-sensitive method or the thermal transfer method is connected, the same processes as those for the electrophotographic method is applied.

Procedure 3: In a case where the dedicated setting and the alternative setting are not set, the multiplexing processing is not performed.

### (Document ID Extraction Flow)

A processing flow of extracting document ID information will be described.

In step S211 illustrated in FIG. 2B, a print product printed based on data on which the multiplexing encoding processing on document ID information has been performed is read.

In the reading, the print product is set on a scanner device, and in step S211, the document is read. Specifically, the scanner device is controlled to irradiate the print product with LED light, and an image sensor, such as a CCD sensor, which is opposed to each pixel, converts reflected light into an analog electric signal.

In step S212, the above-described analog electric signal is converted into a digital signal, and digital RGB values are input. Any known method may be used in the bitmap obtaining processing. The present exemplary embodiment illustrates an example where the following method is used.

In the present exemplary embodiment, four types of processing, that is, MTF correction processing, input correction processing, shading correction processing, and color conversion processing, are performed on each pixel of the bitmap image formed of the RGB pixel values obtained in step S211.

The MTF correction processing is a process of performing correction relating to the resolution among the scanning performances of the scanner. Specifically, in reading with the scanner, an image is defocused due to a deviation from a focus position, limitations in the performance of a lens itself, or the like. Thus, restoration is performed to some extent by performing filter processing or the like. In practice, in a case where enhancement processing is performed at such a strength that the image is completely restored, a whiteout occurs, or an image noise and a dust pixel are enhanced, and image defects stand out more than the enhancement. Accordingly, the design is performed in such a manner that a balance between the improvement in image quality and image defects is achieved. Description is given below of an example in which an edge enhancement filter that multiples pixel values in an image center portion fivefold and that multiples pixel values in upper, lower, left, and right portions by −1 is used to simplify the description.

$${R}^{′} [ x ] [ y ] = R [ x ] [ y ] \times 5 - R [ x - 1 ] [ y ] - R [ x + 1 ] [ y ] - R [ x ] [ y - 1 ] - R [ x ] [ y + 1 ]$$

$${G}^{′} [ x ] [ y ] = G [ x ] [ y ] \times 5 - G [ x - 1 ] [ y ] - G [ x + 1 ] [ y ] - G [ x ] [ y - 1 ] - G [ x ] [ y + 1 ]$$

$${B}^{′} [ x ] [ y ] = B [ x ] [ y ] \times 5 - B [ x - 1 ] [ y ] - B [ x + 1 ] [ y ] - B [ x ] [ y - 1 ] - B [ x ] [ y + 1 ]$$

The input correction processing is a process of converting an output value, which is originally a photon amount of the CCD sensor, into lightness matching the sensitivity of human eyes. Specifically, for example, R′G′B′ signals with 4096 levels for each color are converted into color intensity values R″, G″, and B″ with 1024 levels for each color. This is implemented by performing processing as described below by using a one-dimensional look-up table Table4[4][4096] in which suitable print dot count ratios are set for the densities of the respective ink colors.
R″=Table4[0][R′]
G″=Table4[1][G′]
B″=Table4[2][B′]
   A technique for reducing the table size may also be used, for example, by reducing the number of grids in the look-up table from 4096 grids to, for example, 256 grids or the like, and determining the output values by interpolating table values of multiple grids.

The shading correction processing is a process of reducing color unevenness or density unevenness caused by variations in reading sensitivities at the respective pixel positions caused by manufacturing variations or assembly variations in the lens, LED, and CCD included in the scanner device. Specifically, for example, the R″G″B″ signals with 1024 levels for each color are converted into color intensity values R′″, G′″, and B″ with 256 levels for each color. This is implemented by performing processing as described below on each signal in a direction (X-direction) in which scanner lenses are arranged by using a one-dimensional look-up table Table5[x][3][1024] for density conversion for each X pixel position.
R′″=Table5[x][0][R″]
G′″=Table5[x][1][G″]
B′″=Table5[x][2][B″]
   A technique for reducing the table size may also be used, for example, by reducing the number of grids in the look-up table from 1024 grids to, for example, 256 grids or the like, and determining the output values by interpolating table values of multiple grids.

Lastly, the color conversion processing is performed. Since R″, G′″, and B″ values calculated are values unique to the scanner device, the color conversion processing is performed to convert R″, G′″, and B″ values into Rout, Gout, and Bout values suitable for displaying on the display, conversely to the color conversion processing during printing.

To implement this processing, since each of R′″, G″, and B′″ values that are the input values has 256 levels, a table Table6[256][256][256][3] having 256×256×256, that is, a total of 16,777,216 combinations of output values, is prepared as in the color conversion processing during printing. Then, the color conversion processing is implemented by performing processing as follows.
Rout=Table1[R′″][G′″][B′″][0]
Gout=Table1[R′″][G′″][B′″][1]
Bout=Table1[R′″][G′″][B′″][2]
   A technique for reducing the table size may also be used, for example, by reducing the number of grids in the look-up table from 256 grids to, for example, 16 grids or the like, and determining the output values by interpolating table values of multiple grids.

The processing of obtaining the bitmap image in step S212 is completed by performing the procedures as described above. In the series or processes, in a case where the bitmap image is obtained from the multiplexed print product, thin lines and isolated dots are further reduced in thickness due to degradation during scanning in comparison with the multiplexed image obtained by the multiplexing encoding processing.

In step S213, multiplexed document ID information is extracted.

In the extraction method, determination of whether the marker pattern illustrated in FIG. 5C is printed is performed, a marker region is identified, and the image is divided into 8×8 pixel block units based on the marker region. Then, determination of which one of the patterns illustrated in FIGS. 5A and 5B is printed is performed, and information indicating “0” or “1” is extracted. This processing is repeatedly performed to decode the multiplexed information.

An outline of the multiplexed information decoding processing will be described below.

A position where the multiplexed information is embedded in the obtained bitmap image is detected. Specifically, spatial frequency characteristics on each region of 8×8 pixels in the bitmap image are analyzed, to detect the embedded position.

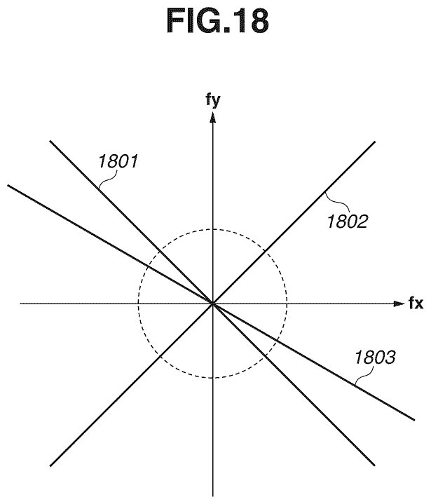

FIG. 18 is a diagram illustrating spatial frequency characteristics of a pattern used for embedding. A horizontal axis represents frequencies in the horizontal direction, and a vertical axis represents frequencies in the vertical direction. The farther from the origin, the higher the frequency range. In the present exemplary embodiment, three types of patterns are embedded as illustrated in FIGS. 4A to 4C. In an embedding example, a value “10” is added to and subtracted from the B component among the R, G, and B components. Thus, the pattern illustrated in FIG. 4A generates a large power spectrum on a line 1801. Similarly, the pattern illustrated in FIG. 4B generates a large power spectrum on a line 1802. Similarly, the pattern illustrated in FIG. 4C generates a large power spectrum on a line 1803.

By detecting a power spectrum, the marker portion is detected. Then, the information portion is identified based on the marker portion and data “0” or “1” in which the information portion is embedded is extracted. The power spectrum may be intensified by performing edge detection as pre-processing of the detection process.

In the data extraction by the frequency analysis, accurate extraction of an analysis area from the image data is required. For this reason, processing of correcting misalignment of coordinate positions is performed. For example, the operation of cutting out a unit area of 8×8 pixels from the bitmap image and the frequency analysis operation are repeated in the vertical and horizontal directions while shifting the area by one pixel. The operations are repeated on the image size of 8 pixels in width and 8 pixels in height, that is, 64 times in total. Then, the position at which the spectrum is most intense is set as a reference position for extracting the marker portion. In this manner, the marker portion is accurately detected, and the multiplexed information in the information portion is extracted from the marker portion, so that the embedded number sequence of “0” and/or “1” is obtained.

In the present exemplary embodiment, as described above in step S204, the multiplexed information to be embedded is set as text document data and text codes are converted into numerical values in “Shift JIS” in advance.

Like 1-byte codes (half-width texts) in Shift JIS, as described above, the alphabetical text “h” corresponds to binary data “01101000”, “e” corresponds to binary data “01100101”, “l” corresponds to binary data “01101100”, and “o” corresponds to binary data “01101111”.

In a case where the number sequence of the extracted additional information is “0110100001100101011011000110110001101111”, a character string of the English word “hello” is obtained.

In practice, the document ID information embedded in step S204 is extracted as additional information, and then the processing ends.

In a case of the embedded information to which the processing according to the present exemplary embodiment is applied, a failure highly likely occurs in the extraction processing on a copy of the print product on which normal copying processing has been performed.

In step S214, determination of whether the document ID information has been successfully extracted is performed.

In a case where it is determined that the document ID information has been successfully extracted (YES in step S214), the processing proceeds to step S215. In a case where the extraction has failed (NO in step S214), the document ID information is not extracted, and then the processing ends.

In the failure case, i.e., determination result indicates “NO”, there are the following two possibilities.

Possibility 1. A case where document ID information is not embedded in the print product scanned in step S211.
Possibility 2. A case where, while document ID information has been embedded in the document, the print product is copied and embedded data cannot be properly read due to, for example, degradation due to copying or the like, dirt on the print product, or a large number of texts or the like being additionally written by hand afterward.

In the case of the possibility 1, the processing is simply terminated. On the other hand, in the case of the possibility 2, the user may be notified of the “possibility that the print product may be a copy of the authentic document”. In the present exemplary embodiment, the determination that there is the possibility 2 may be performed in a case where information of 1 bit to 31 bits out of the 32-bit of the document ID information is extracted in step S213. Considering a case in which the image accidentally includes a certain pattern similar to the predetermined pattern, it may be desirable to determine that there is the possibility 2, in a case where information of equal to or more than 16 bits to equal to or less than 32 bits, which are at least half of 32 bits, is extracted.

In step S215, the document ID information extracted is checked.

In this process, like in step S202, the host PC 50 requests an external PC via the network I/F 507 to verify the authenticity of the extracted document ID information. In this processing, a plurality of PCs has a configuration of a blockchain to manage document data and document ID information, whereby an alteration risk of the document ID is reduced.

In step S216, determination of whether the document ID is a valid document ID is performed as a result of checking the document ID information. In a case where the document ID is a valid document ID (YES in step S216), the processing proceeds to step S217. In a case where the document ID is an invalid document ID (NO in step S216), the processing ends.

Also, in a case where the determination result in step S216 is “NO”, the user may be notified of the “possibility that the print product may be a copy of the authentic document”.

In step S217, document alteration checking processing is performed. In the document alteration checking processing, the host PC 50 obtains document data based on the document ID information from the external PC via the network I/F 507. Like in step S203, the host PC 50 performs the document data rendering processing. Then, the rendering result is compared with the scanning result, whereby determination of whether an alteration is present is performed.

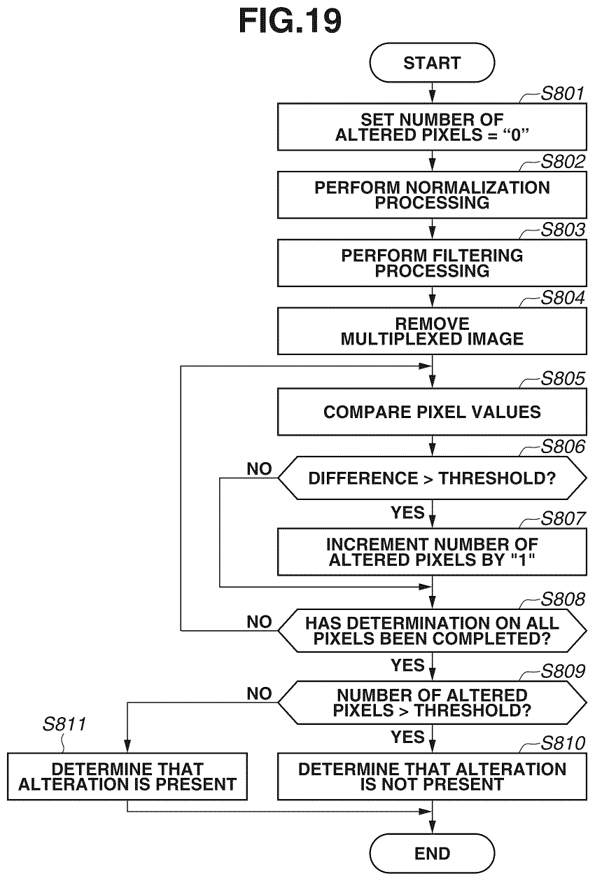

FIG. 19 is a flowchart illustrating processing of detecting whether a document is altered.

In step S801, initialization processing is performed. The number of altered pixels=0 is set.

In step S802, normalization processing is performed on the scanned bitmap image. This is because the bitmap image and the rendering image have different dynamic ranges, and thus direct comparison of the bitmap image with the rendering image is inappropriate.

For example, the lightest portion of the bitmap image is generally the color of paper of a print product and, in principle, has a value of a certain density. The lightest portion of the rendering image is represented by pixels with pixel values of R=255, G=255, and B=255. Accordingly, the two images naturally have different lightest colors.

Similarly, the darkest portion of the bitmap image is the black color of ink or toner and, in principle, has a given value of lightness originating from reflected light. The lightest portion of the rendering image is represented by pixels with pixel values of R=0, G=0, and B=0. Accordingly, the two images naturally have different darkest colors.

Also, in the tone of a color document, the saturation of the most vivid printable red color on the print product is lower than that of the pixel values (R=255, G=0, B=0) indicating the most vivid red color on the rendering image.

Accordingly, the following expressions are applied to the pixel values R, G, and B of the bitmap image.

$$Rnorm = ( R - Rd ) / ( Rw - Rd ) \times 255$$

$$Gnorm = ( G - Gd ) / ( Gw - Gd ) \times 255$$

$$Bnorm = ( B - Bd ) / ( Bw - Bd ) \times 255$$

Thus, the lightest color of the bitmap image with pixel values of R=255, G=255, and B=255, and the darkest color of the bitmap image with pixel values of R=0, G=0, and B=0 can be obtained.

In step S803, filter processing is performed. This is because the edge enhancement in the above-described MTF correction processing is within a visually suitable range, but on the other hand, the filter processing is to apply stronger edge enhancement for image comparison.

In step S804, multiplexed image removal processing is performed. The processing is performed because the generation of the multiplexed image in step S203 illustrated in FIG. 2A causes a difference between the document data to be restored and the print product, and is performed to remove the difference as much as possible. Specifically, since the embedded data in the image data has been extracted from the scanned multiplexed data, processing of subtracting the embedded data brings the scanned image data closer to the document data which is in the state before embedding. In step S805, image comparison processing is performed. According to the present exemplary embodiment, in step S805, an image A that has been rendered in step S203 based on the document data is compared with an image B obtained in step S804 by the multiplexed image removal processing has been performed in units of pixels.

$$Δ R = \vert R [ x ] [ y ] of image A - R [ x ] [ y ] of image B \vert$$

$$Δ G = \vert G [ x ] [ y ] of image A - G [ x ] [ y ] of image B \vert$$

$$Δ B = \vert B [ x ] [ y ] of image A - B [ x ] [ y ] of image B \vert$$

In step S806, determination of whether the difference between pixel values exceeds a threshold is performed. In the present exemplary embodiment, Rth, Gth, and Bth thresholds are set for R, G, and B channels, respectively, and are determined as follows.
If((ΔR>Rth)∥
(ΔG>Gth)∥
(ΔB>Bth)){“Yes”}
Else {“No”}
   While, in the present exemplary embodiment, Rth=Gth=Bth=64 is set as the thresholds, the thresholds Rth, Gth, and Bth are desirably set appropriately in accordance with the characteristics of a scanning device and a printing device.

In a case where the difference is not greater than the threshold (NO in step S805), the processing proceeds to step S808. In a case where the difference is greater than the threshold (YES in step S805), the processing proceeds to step S807.

In step S807, the number of altered pixels is incremented by “1”, and then the processing proceeds to step S808.

In step S808, determination of whether the determination on all pixels has been completed is performed.

In a case where the determination on all pixels has not been completed (NO in step S808), the processing returns to step S805 to continue the process. In a case where the determination on all pixels has been completed (YES in step S808), the processing proceeds to step S809.

In step S809, determination of whether the number of altered pixels exceeds a threshold is performed. In a case where the number of altered pixels exceeds the threshold (YES in step S809), the processing proceeds to step S810. In step S810, it is determined that no alteration is present, and then the processing proceeds to step S218.

In a case where the number of altered pixels does not exceed the threshold (NO in step S809), the processing proceeds to step S811. In step S811, it is determined that an alteration is present, and then the processing proceeds to step S218.

In the present exemplary embodiment, a case where, for example, dust in the scanned image contaminates the data is considered, and the number of altered pixels is set to 3% of the total number of pixels. The threshold may be appropriately set in accordance with the characteristics and the like of the printing device and the scanning device.

In step S218, determination of whether no alteration is present in the scanned image is performed. In a case where it is determined that no alteration is present in the scanned image (YES in step S811), the authenticity of the document is increased as the document with no alteration. In a case where it is determined that an alteration is present in the scanned image (NO in step S218), the user may be notified of the “possibility that the print product may be a copy of the authentic document”. This provides an opportunity for the user to check whether an alteration is present in the authentic document.

According to the present exemplary embodiment described above, authenticity information is embedded in a print product with an embedded shape having features of the present exemplary embodiment, so that the peak direction and cycle of the frequency change before and after copying the print product, and the scanning accuracy of the document after copying deteriorates. As a result, the risk of extracting authenticity information from the document obtained by copy printing is reduced.

As a second exemplary embodiment, a case where a document ID is extracted from a multiplexed print product by a mobile device including an imaging function, such as a smartphone or a camera, will be described.

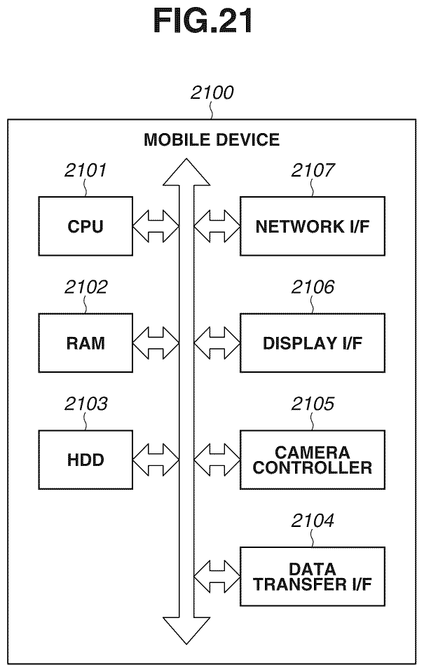

FIG. 21 is a block diagram illustrating a configuration of a mobile device 2100. As illustrated in FIG. 21, the mobile device 2100 mainly includes the following elements. A CPU 2101 executes processing based on programs held in an HDD 2103 and a RAM 2102.

The RAM 2102 is a volatile storage, and temporarily holds programs and data. The HDD 2103 is a non-volatile storage and also holds programs and data.

A data transfer I/F 2104 controls data transmission and reception via wired communication using a USB or the like and performs data transmission and reception with a PC via the USB.

A camera controller 2105 controls an imaging unit (not illustrated) and performs general imaging processing. The camera controller 2105 performs analog-to-digital (A/D) conversion on an imaging signal captured by an image sensor and converts the imaging signal into digital pixel values. Further, the camera controller 2105 performs color interpolation processing using demosaicing processing to convert the values into an RGB image. The camera controller 2105 performs image processing, such as brightness adjustment, white balance adjustment, and sharpness adjustment, on the RGB image, compresses the RGB image into a JPEG image or the like, and holds the compressed image in the HDD 2103.

A display I/F 2106 controls display on a display (not illustrated) and obtains information about a tap operation performed on the display by the user.

A network I/F 2107 wirelessly connects the mobile device 2100 to an external network and issues a document ID check request, a result request, a document data request, and the like.

A description will be given of a setting of regions corresponding to the marker portion and the information portion in print processing including the multiplexing encoding processing in the mobile device 2100.

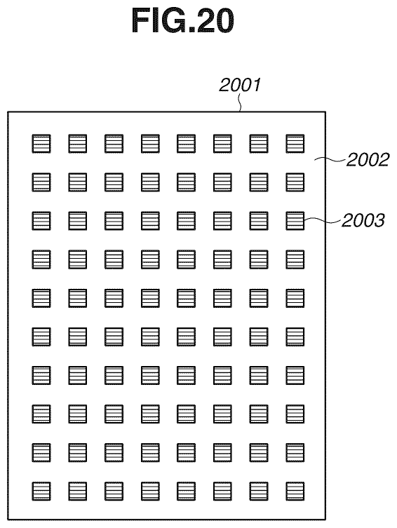

FIG. 20 is a diagram illustrating regions on which document ID information is to be superimposed on a bitmap image. In the case of extracting embedded data from the multiplexed document, the region in which document ID information has been embedded is identified using a marker. Thus, a region in which document ID information is embedded and a marker region to identify the region are set on the bitmap image to be printed on the document, and the multiplexing processing is executed on each of the region and the marker region.

An entire bitmap image 2001 to be multiplexed includes a region 2002 in which document ID information is to be embedded and marker regions 2003 in the document. The marker regions 2003 are arranged at regular intervals within the document.

In a general case of scanning that is performed by a copying machine, the document is highly likely included in the scanned image. For example, in a case of scanning an A4-size document, the A4-size document is placed on a platen glass in such a manner that the document is within the area of the platen glass. Thus, the scanned image includes the entire A4-size document.

On the other hand, in a case of scanning the document using the imaging function of the mobile device 2100, the imaging range changes in accordance with the distance between the mobile device 2100 and the document. In a case where the mobile device 2100 is far apart from the document, the document is within a range of a part of the captured image. In a case where the mobile device 2100 is close to the document, the document does not fit in the range of the captured image, so that a part of the document falls outside the imaging range in some cases.

In a case where the distance between the mobile device 2100 and the document is not constant, the location of the frequency peak is not constant in extraction of the document ID, and thus analysis of the frequency is to be performed while changing the magnification of the captured image.

Specifically, a frequency peak does not appear at a location where the line 1803 and a circle illustrated in FIG. 18 intersect with each other, but appears at any location on the line 1803.

Thus, in the case of extracting the document ID from the multiplexed print product using the mobile device 2100, the marker region to be used in identifying the location is more important. Also, even in a case the imaging range is smaller than the area of the document (an image of only a part of the document is captured), the marker portions are arranged at regular intervals in such a manner that the marker portions are to be extracted. The multiplexing encoding processing that is performed on regions other than the marker portions and the information portion is similar to that according to the first exemplary embodiment.

The processing of extracting the document ID of the multiplexed print product using the imaging unit of the mobile device 2100 is similar to that according to the first exemplary embodiment, and thus the redundant description is omitted. As described above, in a case where the location and size of the multiplexed print product in the captured image are unknown, detection of the marker portion is performed while changing the magnification of the captured image. The extraction processing flow after the detection of the marker portion is similar to that according to the first exemplary embodiment.

As described above, according to the second exemplary embodiment, in extracting the document ID using the mobile device 2100, the effect of the copy prevention processing in which the mask for the copy prevention processing as illustrated in FIG. 6C is applied to the marker portion during creation of a multiplexed image is higher than the effect of the copy prevention processing in which the mask for the copy prevention processing is applied to the information portion. This is because identifying the marker portion is difficult in extraction of the document ID from the captured image using the mobile device 2100.

The exemplary embodiments can also be realized by processing in which a program for realizing one or more functions of the exemplary embodiments is supplied to a system or an apparatus via a network or a storage medium, and one or more processors in a computer of the system or the apparatus read and execute the program. Embodiments of the present disclosure can also be realized by a circuit (for example, an ASIC) that realizes one or more functions.

According to embodiments of the present disclosure, authenticity information is embedded in a print product with an embedded shape having features according to the present disclosure, so that the peak direction and cycle of the frequency change before and after copy printing of the print product, which leads to deterioration in the document scanning accuracy after the copy printing. Consequently, the risk of extracting authenticity information from the document after copy printing is reduced.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-019860, filed Feb. 13, 2024, which is hereby incorporated by reference herein in its entirety.

What is claimed is:

1. An image processing apparatus that embeds a pattern including a specific frequency characteristic in print data to add additional information to the print data, the image processing apparatus comprising:
a print data obtaining unit configured to obtain data to be printed on a print medium; and
a multiplexing unit configured to perform multiplexing processing on the additional information to be embedded in the print data,
wherein the additional information to be subjected to the multiplexing processing by the multiplexing unit is formed of a first shape and a second shape within a region on the print medium, and
wherein the first shape is created based on the additional information, the second shape contacts with the first shape, and a part of the first shape is larger than another part of the first shape.

2. The image processing apparatus according to claim 1, wherein the shapes to be embedded are created by the multiplexing unit in such a manner that a small dot is used for the first shape and a large dot is used for the second shape.

3. The image processing apparatus according to claim 1, wherein the multiplexing unit performs the multiplexing processing on a lightness component in the print data.

4. The image processing apparatus according to claim 1, wherein the multiplexing unit performs the multiplexing processing on a saturation component in the print data.

5. The image processing apparatus according to claim 1, wherein an embedded shape combined from the first shape and the second shape on the print medium obtained by an electrophotographic method is smaller than the embedded shape combined from the first shape and the second shape on the print medium obtained by an inkjet method.

6. The image processing apparatus according to claim 1, further comprising:
an information obtaining unit configured to obtain the additional information;
a second multiplexing unit configured to create the embedded shape based on the additional information obtained by the information obtaining unit; and
a selection unit configured to select one of the embedded shape created by the multiplexing unit and the embedded shape created by the second multiplexing unit,
wherein the multiplexing unit performs the multiplexing processing on print data obtained by the print data obtaining unit with the embedded shape selected by the selection unit, and
wherein the embedded shape created by the second multiplexing unit is formed of the first shape.

7. The image processing apparatus according to claim 1, wherein the additional information is authenticity information indicating authenticity of a document represented by the print data.

8. The image processing apparatus according to claim 1, wherein the print data includes an information region in which the additional information is to be embedded, and a marker region to be used for identifying of the information region.

9. An image processing method for embedding a pattern including a specific frequency characteristic in print data to add additional information to the print data, the image processing method comprising:
obtaining print data to be printed on a print medium; and
performing multiplexing processing on the additional information to be embedded in the print data,
wherein the additional information to be subjected to the multiplexing processing is formed of a first shape and a second shape within a region on the print medium, and
wherein the first shape is created based on the additional information, the second shape contacts with the first shape, and a part of the first shape is larger than another part of the first shape.

10. A non-transitory computer-readable storage medium storing instructions that, when executed by a computer, cause the computer to perform a method for embedding a pattern including a specific frequency characteristic in print data to add additional information to the print data, the image processing method comprising:
obtaining print data to be printed on a print medium; and
performing multiplexing processing on the additional information to be embedded in the print data,
wherein the additional information to be subjected to the multiplexing processing is formed of a first shape and a second shape within a region on the print medium, and
wherein the first shape is created based on the additional information, the second shape contacts with the first shape, and a part of the first shape is larger than another part of the first shape.
